(19) United States
(12) Patent Application Publication
(10) Pub. No.: US 2008/0022870 A1
(43) Pub. Date: Jan. 31, 2008

(54) FLEXO PRINTING SCREEN ROLLER AND FLEXOGRAPHY

(75) Inventor: Rainer STAMME, Augsburg (DE)

Correspondence Address: CROWELL & MORING LLP;INTELLECTUAL PROPERTY GROUP, P.O. BOX 14300, WASHINGTON, DC, 20044-4300, US

(73) Assignee: MAN Roland Druckmaschinen AG, Augsburg (DE)

(21) Appl. No.: 11/774,440

(22) Filed: Jul. 6, 2007

(30) Foreign Application Priority Data
Jul. 8, 2006 (DE) 10 2006 031 682.7

(51) Int. Cl. B41M 1/12; B41F 1/46

(52) U.S. Cl. 101/129; 101/348

(57) ABSTRACT

A flexo printing screen roller having a surface, which has cells which can be filled with ink or paint, is disclosed. The cells have different depths in order to apply ink or paint of varying thickness to a flexo printing form and thus ultimately to a substrate to be printed.

This application claims the priority of German Patent Document No. 10 2006 031 682.7, filed Jul. 8, 2006, the disclosure of which is expressly incorporated by reference herein.

### BACKGROUND AND SUMMARY OF THE INVENTION

The invention relates to a flexo printing screen roller. The invention further relates to flexography.

For those printing processes using print forms, a distinction is made principally between letterpress, rotogravure, flatbed printing and screen printing; flexo printing is a special letterpress process. Flexo printing is used especially in printing packaging, labels and newspapers. In flexo printing, printing ink is applied by means of an ink supplying device, in particular by means of an ink chamber blade, to a flexo printing screen roller which transfers the ink to a flexo printing form which finally applies the ink to the substrate to be printed. Flexo printing screen rollers known from practice have on one surface a grid of cells which can be filled with ink by means of the ink supply device whereby the ink from the cells reaches the flexo printing form, namely raised image elements of the form. All the cells on flexo printing screen rollers known from practice have an identical depth, from which it follows that ink can only be applied in flexo printing to the substrate with a uniform thickness or film build. As a result, the design possibilities achievable for print products are limited.

The problem underlying the present invention is to create a novel flexo printing screen roller as well as a novel flexo printing method, using both of which ink or paint can be applied to a substrate to be printed at varying thicknesses.

In accordance with the invention, the cells have different depths in order to apply ink or paint with a different thickness to a flexo printing form and thus ultimately to a substrate to be printed.

For the first time it is possible using the flexo printing screen roller in accordance with the invention to apply ink or paint as well with a different or variable thickness or film build in flexo printing to a substrate to be printed. This may be done depending on the print image or independently of the print image. As a result, totally new design possibilities emerge for print products produced with the aid of flexo printing methods.

Preferably the surface has recesses which all have the same dimensions, in particular the same depth, where the recesses can be filled equally and completely with filler material and where subsequently the filler material can be removed individually from the recesses, providing the cells with different depths.

Preferred further developments of the invention can be found in the subsequent description. Embodiments of the invention are explained in more detail using the drawings, without being restricted thereto.

### BRIEF DESCRIPTION OF THE DRAWINGS

FIG. 1 shows a schematized section from one surface of a flexo printing screen roller in accordance with the invention which has recesses on the surface which all have the same dimensions, in particular the same depth.

FIG. 2 shows the section from the surface from FIG. 1, where the recesses are filled equally and completely with filler material.

FIG. 3 shows the section from the surface from FIGS. 1 and 2, where the filler material is removed individually from the recesses, providing the cells with different depths.

FIG. 4 shows the section from the surface from FIG. 1, where the recesses are being filled equally and completely with filler material.

FIG. 5 shows the section from the surface from FIGS. 1 and 2, where filler material is being removed individually from the recesses.

FIG. 6 shows the section from the surface from FIGS. 1 to 5, where filler material is being removed completely from the recesses.

FIG. 7 shows a first image to clarify the flexo printing method in accordance with the invention.

FIG. 8 is a second image to further clarify the flexo printing method in accordance with the invention.

### DETAILED DESCRIPTION OF THE DRAWINGS

The present invention relates to the field of flexo printing. Flexo printing is a special letterpress process. In flexo printing, ink or paint is applied to a flexo printing screen roller with the aid of an ink supply device which is in particular configured as an ink chamber blade. The flexo printing screen roller rolls against a form cylinder on which a flexo printing form is located to transfer the ink or the paint to the flexo printing form. The flexo printing form ultimately applies the ink or the paint to the substrate.

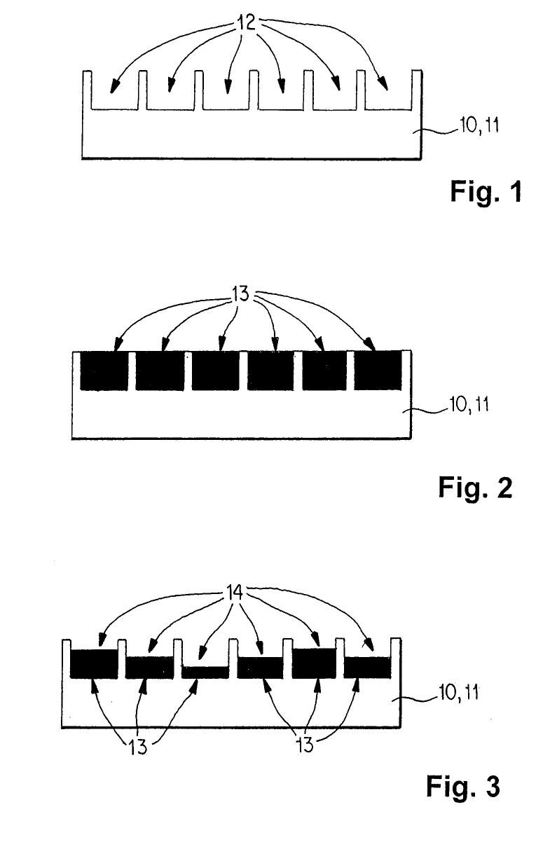

FIGS. 1 to 3 show a section from a surface 10 of a flexo printing screen roller 11 in various states, where FIG. 3 shows a section from the surface 10 of the flexo printing screen roller 11 as it is used for printing.

The flexo printing screen roller 11 has on its surface 10 a grid of recesses 12 which preferably all have the same dimensions, in particular the same depth. The recesses 12 are completely filled with a filler material 13 in the representation from FIG. 2. In order to prepare cells 14 with varying depths which are filled with ink or paint for printing, filler material is removed varyingly or individually from the recesses in FIG. 3. Using such a flexo printing screen roller 11 which has cells 14 on its surface of varying depths, ink or paint with varying thickness or film build can be applied to a flexo printing form and thus to a substrate to be printed. As a result it becomes possible in flexo printing for the first time to apply ink layers or paint layers of varying thickness to a substrate.

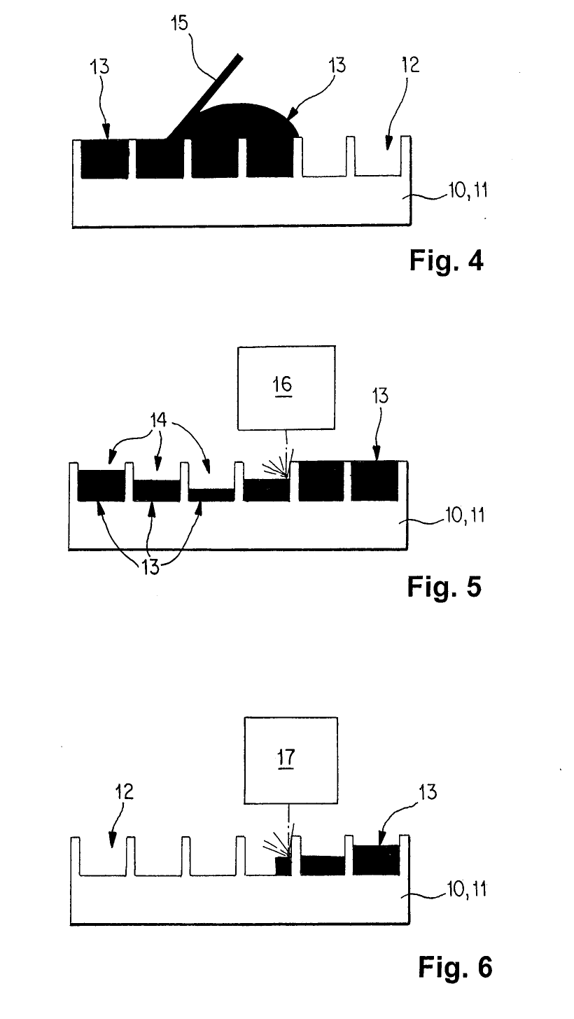

In order to provide the flexo printing screen roller shown in FIG. 3, the procedure is typically that the recesses 12 of a printing form which are completely empty are filled completely or entirely with filler material 13 with the aid of a doctor blade 15 in accordance with FIG. 4, such that the screen roller 11 afterwards has a smooth surface. The individual removal of the filler material 13 from the recesses 12 to prepare the flexo printing screen roller 11 shown in FIG. 3 is carried out in accordance with FIG. 5, preferably using a laser 16. If no flexo printing screen roller 11 with completely empty recesses 12 is available, before filling the recesses 12 with filler material in accordance with FIG. 6 a flexo printing screen roller 11 which has already been used for printing is erased with the aid of an eraser 17, wherein the filler material 13 is removed completely from the recesses 12 with the aid of the eraser 17.

The flexo printing screen roller 11 in accordance with the invention is therefore an erasable and imageable screen roller, where imaging should be understood to mean the preparation of cells 14 of varying depth on the surface 10 of the flexo printing screen roller 11.

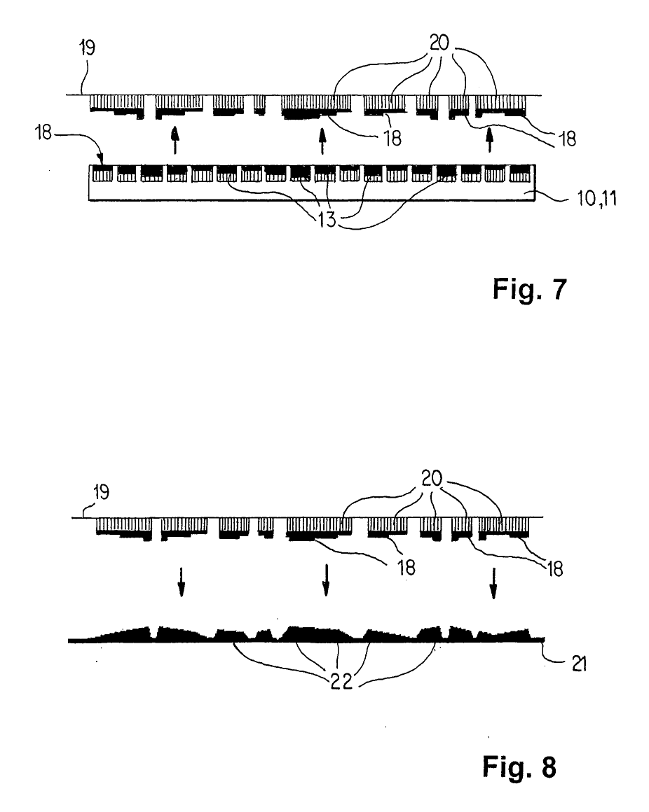

The depth of the cells 14 determines the dipping volume of the cells, or the holding capacity of the cells for ink or paint and thus ultimately the thickness or film build of the ink or paint which is applied to a substrate. This is described hereinafter in greater detail with reference to FIGS. 7 and 8.

FIG. 7 again shows a section from a surface 10 of a flexo printing screen roller 11, where the filler material 13 with which the recesses 12 of the flexo printing screen roller 11 are filled to different levels is represented in FIG. 7 by striped areas and not as in FIGS. 1 through 5 by totally black areas. The cells 14 of varying depth on the flexo printing screen roller 10 are shown filled with ink 18 in FIG. 7, where the ink 18 in FIG. 7 is visualized by black areas. The cells 14 of the flexo printing screen roller 11 which, because of their varying depth, contain a different quantity of ink transfer the ink 18 in the printing process to a flexo printing form 19, that is, to raised printing elements 20 of the flexo printing form 19. From these raised printing elements 20 of the flexo printing form 19 the ink 18, in accordance with FIG. 8, reaches a substrate 21 and forms areas 22 on the substrate 21 which have a different thickness or film build of ink.

The cells 14 of the screen roller 11 can have the different depths and thus dipping volumes for ink or paint either depending on, or independently of, the print image. If the cells have different depths depending on the print image, the individual removal of the filler material 13 from the recesses 11 then takes place in the sense of FIG. 5, depending on print data of the print image to be printed. In this case, the diameter of the flexo printing screen roller must match the diameter of the form cylinder which carries the flexo printing form.

It is similarly possible that the cells have different depths independently of the print image, where this is used in particular to prepare, for example, areas with varying thicknesses or film build of ink or paint in the circumferential direction or in the left-right dimension.

A polymer is preferably used as filler material 13. The polymer used as filler material 13 must be ink-resistant or paint-resistant respectively so that its properties are not degraded during printing. Furthermore, the polymer used as filler material must possess resistance to abrasion so that during the mechanical doctoring process the filler material 13 is not damaged. Similarly, the polymer used as filler material 13 must be heat-resistant, so that the polymer can be removed selectively from the recesses using a laser to prepare the cells with varying depth.

Additional properties which the polymer used as filler material 13 should possess are good erasure properties in order to be able to remove the polymer completely from the recesses 12 of the flexo printing screen roller in order to erase the roller, as well as good curing properties so that after the recesses 12 are completely filled with filler material, an immediate start can be made with selective removal to prepare the cells 14 of varying depth.

When appropriate, it may be necessary to handle the recesses completely filled with filler material 13 on their surface before the selective removal of filler material 13 in order to prepare a smooth surface on the flexo printing screen roller 11.

The flexo printing screen roller 11 in accordance with the invention can be designed both as a full roller and as a sleeve. Both variants are possible, however the sleeve version of the flexo printing screen roller is more cost effective.

Using the present invention, an improvement in print quality in flexo printing can be realized. Furthermore, the range of applications, or the spectrum of applications, for flexo printing is expanded. Specifically, pearl effects which can arise on non- or poorly absorptive substrates such as plastic film can be countered using the invention.

### REFERENCE NUMERAL LIST

10 Surface
11 Flexo printing screen roller
12 Recess
13 Filler material
14 Cell
15 Doctor blade
16 Laser
17 Eraser
18 Ink
19 Flexo printing form
20 Print elements
21 Substrate
22 Area

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A flexo printing screen roller, having a surface which has cells which are fillable with ink or paint, wherein the cells have different depths in order to apply ink or paint having a different thickness to a flexo printing form and thus ultimately to a substrate to be printed.

2. The flexo printing screen roller according to claim 1, wherein the surface has recesses which all have same dimensions, in particular a same depth, and the recesses for preparing the cells of varying depth are filled differently with a filler material.

3. The flexo printing screen roller according to claim 2, wherein all recesses are fillable equally and completely to prepare the cells of varying depth and filler material is subsequently removable individually from the recesses while preparing the cells.

4. The flexo printing screen roller according to claim 2, wherein the filler material is an ink-resistant or paint-resistant, abrasion-resistant and heat-resistant polymer.

5. The flexo printing screen roller according to claim 1, wherein the cells have different depths depending on a print image and wherein a diameter of the roller matches a diameter of a form cylinder carrying the flexo printing form.

6. A flexo printing process for printing a substrate with ink or paint, wherein an ink supply device, in particular an ink chamber, applies ink or paint to a flexo printing screen roller according to claim 1 which transfers the ink or paint to a flexo printing form positioned on a form cylinder which applies the ink or the paint to the substrate, wherein the flexo printing screen roller applies ink or paint of varying thickness to the flexo printing form and thus ultimately to the substrate to be printed.

7. A flexo printing screen roller, comprising:
a surface having a first cell and a second cell, wherein the first cell has a first depth and the second cell has a second depth, wherein the first depth is different from the second depth, and wherein different quantities of an ink or a paint is contained in the first cell and the second cell.

8. The flexo printing screen roller according to claim 7, wherein the first cell and the second cell are defined at least in part by a first recess and a second recess, respectively.

9. The flexo printing screen roller according to claim 8, wherein the first recess and the second recess are of a same dimension.

10. The flexo printing screen roller according to claim 8, wherein the first recess and the second recess each contain a filler material and wherein a quantity of the filler material in each of the first and second recesses defines at least in part the first depth of the first cell and the second depth of the second cell, respectively.

11. The flexo printing screen roller according to claim 7 in combination with a flexo printing form and a substrate, wherein the ink or paint is transferred from, the first cell and the second cell to the flexo printing form, wherein the ink is transferred from the flexo printing form to the substrate, and wherein a thickness of the ink or paint transferred to the substrate corresponds to the first depth of the first cell and the second depth of the second cell.

12. A method of printing a substrate with ink or paint, comprising the steps of:
transferring a quantity of the ink or the paint from a first cell and a second cell of a flexo printing screen roller to a flexo printing form, wherein the first cell has a first depth and the second cell has a second depth, wherein the first depth is different from the second depth, and wherein the quantity of the ink or the paint in the first cell is different from the quantity of the ink or the paint in the second cell; and
transferring the ink or paint from the flexo printing form to the substrate, wherein a thickness of the ink or the paint transferred to the substrate corresponds to the first depth of the first cell and the second depth of the second cell.

13. The method according to claim 12, wherein the depth of the first cell and the depth of the second cell is defined at least in part by a filler material in a first recess and by a filler material in a second recess, respectively.

14. The method according to claim 13, wherein the filler material in the first recess and the filler material in the second recess are a remaining portions after a laser process removes a portion of the filler material from the first recess and removes a portion of the filler material from the second recess.

15. The method according to claim 13, further comprising the steps of removing the filler material from the first recess and removing the filler material from the second recess after the ink or the paint is transferred to the flexo printing form.
